(19) United States
(12) Patent Application Publication
(10) Pub. No.: US 2012/0097585 A1
(43) Pub. Date: Apr. 26, 2012

(54) Water Purification System with Entrained Filtration Elements

(75) Inventors: Dennis Chancellor, Gilbert, AZ (US); John Blackman, Fountain Hills, AZ (US)

(73) Assignee: ADVANCED ENERGY SAVING SYSTEMS, Gilbert, AZ (US)

(21) Appl. No.: 13/263,819

(22) PCT Filed: Apr. 9, 2010
(86) PCT No.: PCT/US10/30580

§ 371 Date: Jan. 6, 2012

Related U.S. Application Data
(62) Division of application No. 61/168,496, filed on Apr. 10, 2009.

(51) Int. Cl. B01D 29/56; B23P 11/00; B01D 36/02; B01D 35/00; B01D 29/50; B01D 36/00

(52) U.S. Cl. 210/87; 210/435; 210/437; 210/323.1; 210/295; 210/209; 210/335; 210/90; 210/85; 29/428

(57) ABSTRACT

A filter canister is described that includes at least one filter element and a casing formed about the filter element and having sufficient strength to be used in place of a pressure vessel. The filter canister can have first and second ends. A collector tube can be disposed within the filter element to collect permeate from the filtered fluid. Two or more of the filter canisters can be fluidly coupled in a filtration system. The filter canister can be produced by spool winding a material about the filter element and an end piece to form a casing that can harden in place.

This application claims the benefit of priority to co-pending U.S. provisional application having Ser. No. 61/168,496 filed on Apr. 10, 2009. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is filters.

### BACKGROUND

Typically, filtration devices are composed of one or more filter elements disposed within a pressure vessel. However, such devices are disadvantageous, as they generally require significant upfront costs for the pressure vessel and related components. In addition, such filtration devices generally require anti-telescoping devices (ATDs) to prevent the membrane leaves of the spirally wound filter elements from telescoping under high pressure.

U.S. Pat. No. 7,208,088 to Almasian discusses a filtration cartridge spirally wound around a central tube. As the filtration cartridge lacks an outer casing, the cartridge must be placed within a solid housing to function. Such housings and related fittings are generally expensive, and often have high labor and upkeep costs. For example, to clean or replace the filter element, external equipment must generally be used to eject the filter element from within the cylinder, which adds to the maintenance costs and downtime.

U.S. Pat. No. 7,481,917 to Ikeyama, et al. discusses an alternate embodiment of a filtration device. Ikeyama discusses a reverse osmosis filter comprising an outer shell wrapped around the cartridge. However, Ikeyama contemplates using the outer shell to protect a RFID chip. The shell lacks sufficient strength to withstand the pressure of the fluid. Thus, the Ikeyama device also requires placing the filtration cartridge within a preformed pressure tube, which suffers from the disadvantages described above.

Thus, there is still a need for a filter having a casing formed about the filter element that functions as a pressure vessel. There is also a need for a method of producing such a filter canister that significantly reduces the cost of the filter canister. There is a further need for a filter canister having a casing formed about the filter element that eliminates any dead space between the filter element and the casing.

### SUMMARY OF THE INVENTION

The inventive subject matter provides apparatus and methods in which a filter canister comprises a filter element and a casing formed about the filter element. As used herein, the term “filter element” is defined to include all commercially suitable filters including, for example, sand, charcoal, paper, and other media, and any membrane capable of filtering a fluid. The filter element could be of any type, size or manufacturer, and preferably the filter element is selected based upon the commercial application. This is beneficial as it allows the filter canister to be constructed for use in filtering a variety of contaminants from a fluid.

The casing can be formed in situ about the filter element using any suitable process including for example, winding the casing material about the filter element (e.g., spirally, conically, spool, etc.), injection molding, rotary casting, welding, soldering, and any combinations thereof This is advantageous as the casing is formed to an outer diameter (or diameters) of the filter element, even for example, accommodating for defects in the perimeter of the filter element. This improves the filter canister's efficiency by effectively eliminating dead space between the filter element and the casing. In addition, elimination of the dead space helps to prevent microorganisms from growing between the inner wall of the filter canister and the outer surface of the element, and will also completely eliminate flow-by in the operation of the element. Preferably, once the casing is formed about the filter element, the casing is cured or hardened in place.

The casing is preferably formed from fiberglass or composite fibers, although any commercially suitable materials having sufficient strength to be used in a place of a pressure vessel could be used. Contemplated materials include, for example, fiber reinforced plastics, plastics, composites, stainless steel, carbon steel, AL6XN high nickle alloy or other alloys, exotic metals, and any other metals, and any combination(s) thereof. The term “sufficient strength” is used herein to mean a material strength sufficient to withstand a cross casing pressure difference of at least 40 psi. Preferred material strength is sufficient to withstand a cross casing pressure difference between 40 psi and about 1000 psi, and specific ranges will depend on the application. For example, for filtration of blackish water, preferred materials have a material strength sufficient to withstand a cross casing pressure difference of between about 150 psi and about 600 psi. For the filtration of salt water using a Sea Water Reverse Osmosis (SWRO) process, preferred materials have a material strength sufficient to withstand a cross casing pressure difference of between about 150 psi and about 1000 psi.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a horizontal cross-sectional view of one embodiment of a filter canister.

FIG. 2 is a horizontal cross-sectional view of an embodiment of a filter canister having tapered ends.

FIG. 3 is a horizontal cross-sectional view of another embodiment of a filter canister having tapered ends.

FIG. 4 is a horizontal cross-sectional view of yet another embodiment of a filter canister having tapered ends.

FIG. 5 is a schematic of an embodiment of a filtration system having filter canisters.

FIG. 6 is a flowchart of a method of producing a filtration device from a filter element.

### DETAILED DESCRIPTION

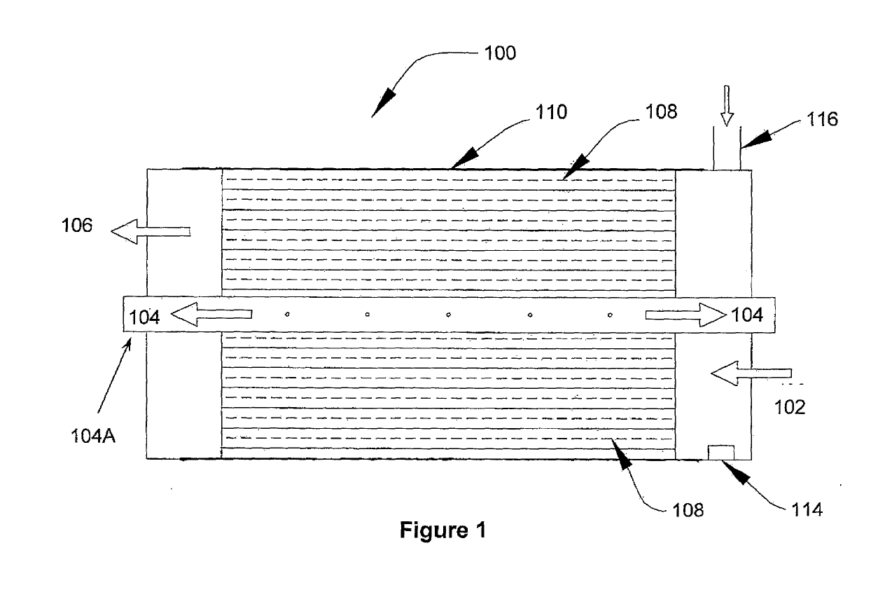

In FIG. 1, filter canister 100 comprises a casing 110 fluidly coupled to a feed fluid inlet 102, a permeate outlet 104, and a flow-by outlet 106. As discussed herein, the term “fluid” includes, for example, water, air and other liquids and gases. The filter canister 100 is preferably mounted in a substantially vertical position, although all orientations are contemplated. As used herein, the term “substantially vertical” means within 15° off perpendicular to the ground. In some contemplated embodiments, two or more filter canisters could be fluidly coupled in parallel or series, such as that shown in FIG. 5. The casing 110 could be of any length, although preferred casings have a length of between 4 ft to 18 ft, and more preferably, between 5 ft to about 15 ft, although the length of the canister will depend on the number of filter elements, the configuration of the canister's end pieces, and the piping coupled to the canister. For example, a canister that includes a single filter element 108 might have a length of about 5 ft, and a canister that includes three filter elements might have a length of about 15 ft.

The feed fluid enters the filter canister 100 via feed fluid inlet 102 and passes through one or more filter elements 108. The permeate outlet 104 collects the permeate from the fluid, and directs the permeate in one or more directions. Although the permeate is depicted as flowing from the permeate outlet 104 in two directions, it is contemplated that the permeate could flow in a single direction, or three or more directions. The permeate outlet 104 is preferably disposed in a central portion of filter canister 100, but the permeate outlet 104 can alternatively be disposed at other locations in filter canister 100 with or without a collection pipe 104A disposed within the filter element 108. The remainder of the feed fluid, which is commonly referred to as flow-by, exits out of the filter canister 100 via flow-by outlet 106.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

In other contemplated embodiments, the feed fluid and the flow-by and permeate could each respectively pass into and out from a single end of the filter canister 100. For example, the filter canister 100 could have a reducer at a first end, and a sealed dome at a second end (not shown). However, by disposing the feed fluid inlet 102 and flow-by outlet 106 on opposite sides of the filter canister 100, the filter canister can advantageously be flipped 180° to accommodate reverse flow through the filter canister 100.

The filter canister 100 optionally can include an injector port 116 that functions to inject water, chemicals, or other fluids into the filter canister 100. This is beneficial as it allows for doping or cleaning of the filter canister 100 without moving the filter canister 100 or requiring removal of filter element 108. By including proper valving, the filter element 108 can be isolated and cleaned in place without removal of the filter element 108 from the filter canister 100. Additionally or alternatively, particles could be dislodged from the filter element 108 by back-flushing the canister and without requiring the canister to be disassembled or moved. For example, clean water can be pumped through the permeate outlet while feed fluid is pumped into the canister through the feed fluid inlet at a slightly lower pressure than the clean water.

The filter canister 100 can also include one or more sensors 114 that measure at least one characteristic of the fluid, including, for example, flow, temperature, pressure, conductivity, and salinity. It is contemplated that the sensor 114 could alternatively be disposed externally to the filter canister 100, such as in a bypass pipe or in a manifold or piping section. Preferably, the sensor 114 includes a wireless transmitter to allow the sensor 114 to wirelessly communicate signals to a remote monitor (not shown).

The filter canister 100 could further comprise a separation sheet disposed between the filter element 108 and the casing 110. Such sheet could be advantageous to protect any sensor 114 or other device from moisture.

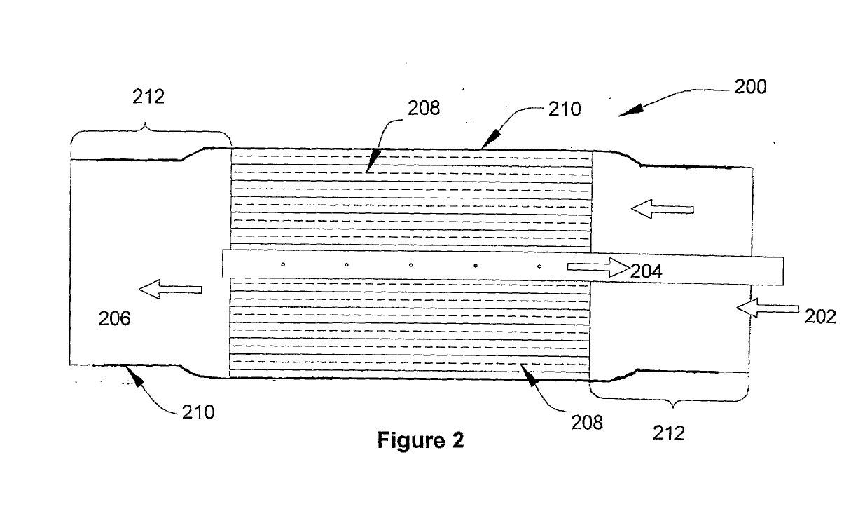

As shown in FIG. 2, canister 200 can have one or more tapered or otherwise reduced ends 212. In some contemplated embodiments, the canister could have a domed end. The ends 212 could be sealed to the canister 200, or removably coupled thereto, and can include one or more O-rings or U-cup rings to prevent leaks. For example, the tapered end 212 could reduce an end having a diameter of 16 inches for the portion of the end nearest to the element 208 to a diameter of 4 inches, which advantageously allows the tapered end 212 of the canister 200 to couple to a manifold or piping system, as shown in FIG. 5, by using commercially suitable fittings and valves. Such tapering is beneficial as it allows the canister 200 to utilize commercially available uniform pipe sizes to optimize flow rates through the pipes and the installation of fittings plus standard commercial valving a specific system design might require. Such tapering also provides a uniform surface for the windings mentioned above to wrap around and prevent the tapered ends from moving away from the element when the system operational pressure is applied. Such tapered or reduced end(s) 212 may be concentrically disposed about a second pipe, as shown in FIG. 7, and be used to transfer fluid into or out from canister 200. This is advantageous as the concentric nature of the second pipe can restrict the flow rate of the canister 200. Alternatively, at least one of the tapered ends 212 may also include a separate pipe disposed eccentrically within the tapered end 212, as shown in FIG. 8, and be used to transfer fluid or instrument sensors into or out from canister 200.

Canister 200 includes a single permeate outlet 204. With respect to the remaining numerals in FIG. 2, the same considerations for like components with like numerals of FIG. 1 apply.

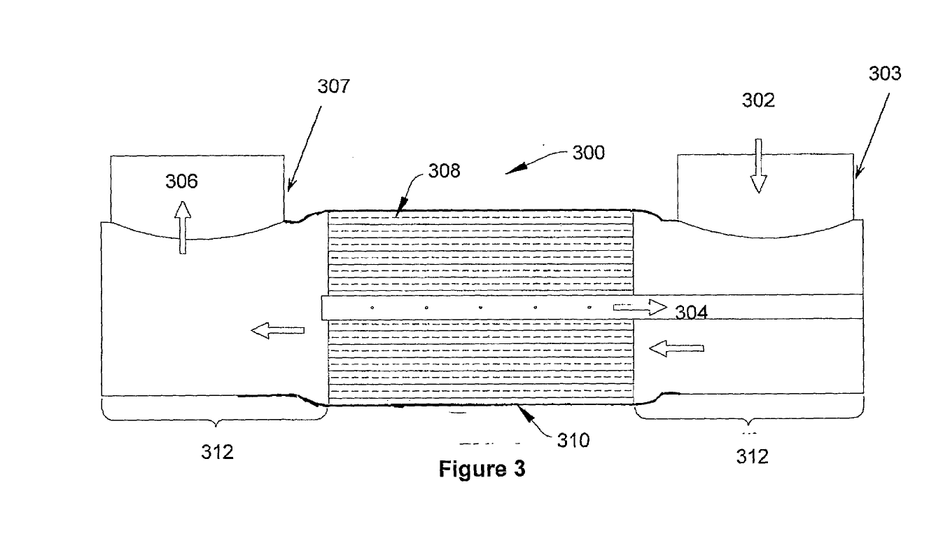

FIG. 3 shows a canister 300 having tapered ends 312 coupled to inlet and outlet piping 303 and 307. With respect to the remaining numerals in FIG. 3, the same considerations for like components with like numerals of FIG. 1 apply.

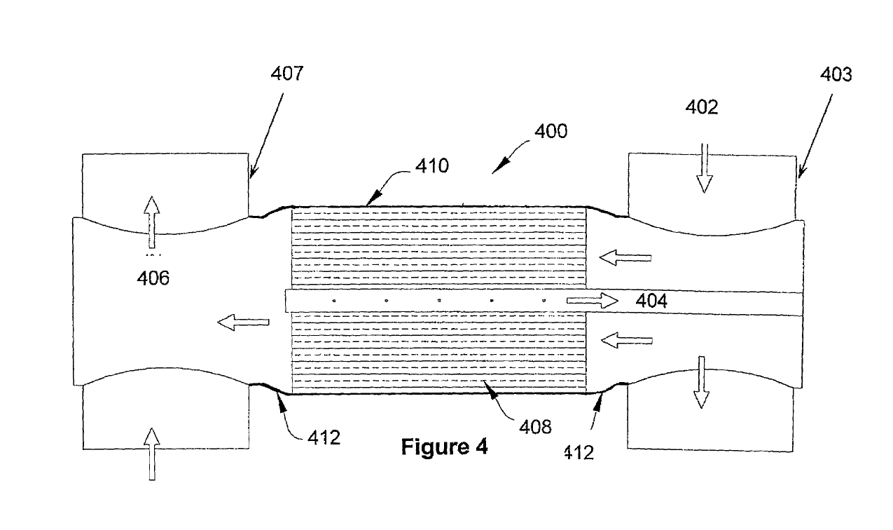

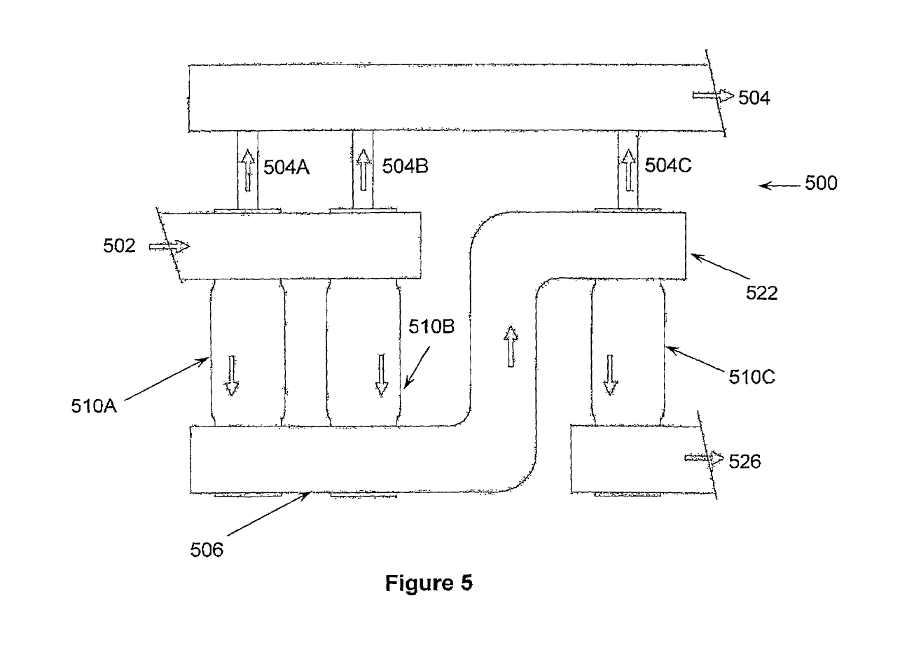

In FIG. 4, another embodiment of a canister 400 is shown having tapered ends 412 coupled to inlet and outlet piping 403 and 407. The piping 403 and 407 can be used to fluidly couple two or more canisters in parallel or serial connections, such as that shown in FIG. 5. With respect to the remaining numerals in FIG. 4, the same considerations for like components with like numerals of FIG. 1 apply.

FIG. 5 illustrates a filtration system 500 having a plurality of filter canisters 510A, 510B, and 510C. Filter canisters 510A and 510B are fluidly coupled in parallel to feed fluid inlet 502 and flow-by outlet piping 506. Each of filter canisters 510A and 510B can have permeate outlets 504A and 504B, respectively, which are coupled to permeate outlet piping 504. The flow-by outlet piping 506 can be fluidly coupled to a second feed fluid inlet 522 that itself is fluidly coupled to filter canister 510C. In this manner, the flow-by produced by filter canisters 510A and 510B is re-filtered and additional permeate can be collected. Although a series of only two sets of canisters is shown, it is contemplated that the filtration system 500 could include three or more sets of filter canisters, each of which could include one or more filter canisters. Preferred filtration systems have a two to one ratio, meaning that one downstream filter canister is used to filter the flow-by output of every two filter canisters disposed upstream, although the specific ratio of filter canisters in each set can vary depending on the application.

The flow-by produced by filter canister 510C is outputted to second flow-by outlet 526, and the permeate produced by filter canister 510C is outputted via permeate outlet 504C to permeate piping 504.

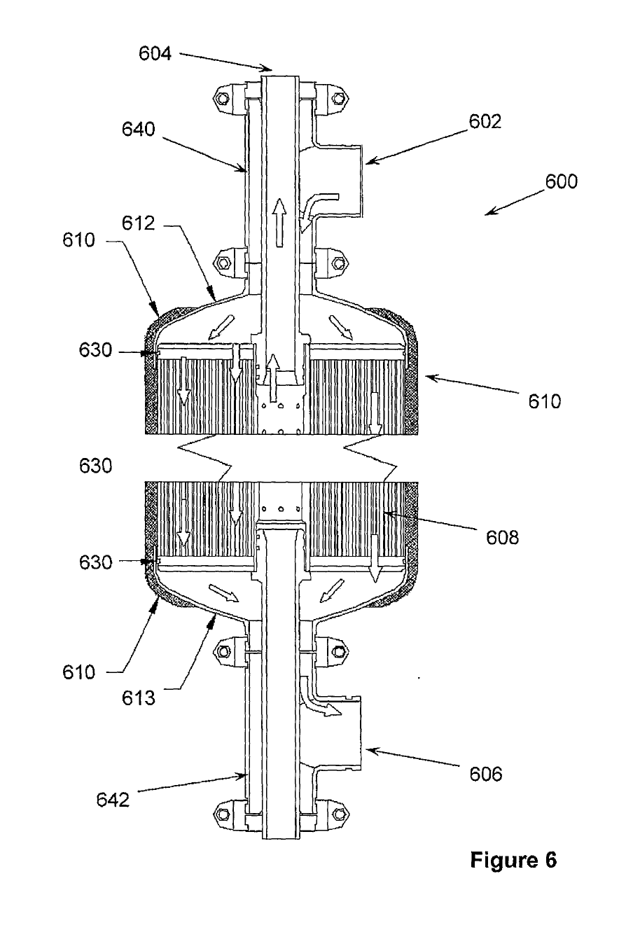

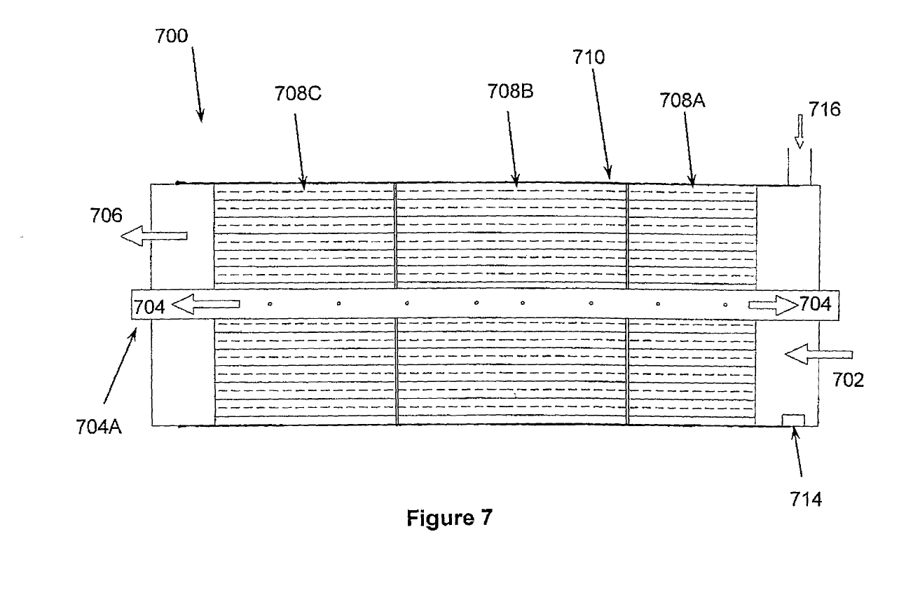

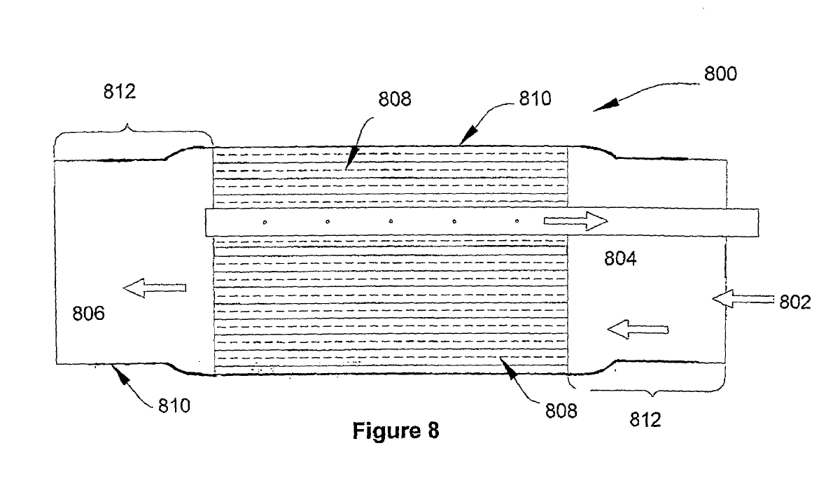

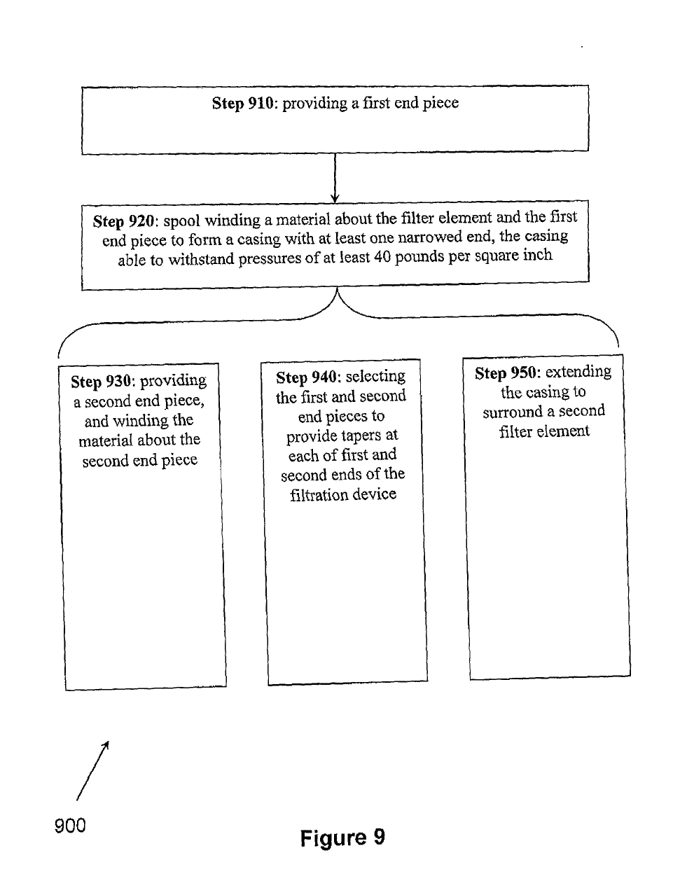

In FIG. 6, an alternate embodiment of a canister 600 is shown having first and second tapered ends 612 and 613. A casing is disposed about a filter element 608 and the first and second tapered ends 612 and 613. O-ring 630 or other commercially suitable sealing element is disposed at each end of the filter element 608. A permeate collection pipe 604 can be disposed in the center of the filter element 608. The permeate collection pipe 604 can be disposed concentrically within the first and second ends 612 and 613, although eccentric placement of the permeate collection pipe 604 with respect to at least one of the first and second ends is also contemplated.

As shown in FIG. 6, the first end 612 is fluidly coupled to a feed fluid inlet piping 640, and the second end 613 is fluidly coupled to a flow-by outlet piping 642. With respect to the remaining numerals in FIG. 6, the same considerations for like components with like numerals of FIG. 1 apply.

In FIG. 7, a filter canister 700 is shown having three filter elements 708A-708C. This is advantageous as it allows the filter canister 700 to include various configurations of filter elements 708A-708C. For example, the first filter element 708A could have a different composition from that of the second filter element 708B. Alternatively, the filter elements could have the same composition. With respect to the remaining numerals in FIG. 7, the same considerations for like components with like numerals of FIG. 1 apply.

FIG. 8 illustrates a filter canister 800 having a permeate outlet 804 that is disposed eccentrically with respect to tapered end 812. With respect to the remaining numerals in FIG. 8, the same considerations for like components with like numerals of FIG. 2 apply.

In one aspect shown in FIG. 9, a method 900 of producing a filtration device from a filter element is disclosed. In step 910, a first end piece is provided. In step 920, a material is spool wound about the filter element and the first end piece to form a casing with at least one narrowed end, with the materials and dimensions of the casing sufficient to withstand a cross casing pressure difference of between about 40 psi and about 2000 psi. Preferably, in step 930, a second end piece is also provided and the material is spool wound about the second end piece to create a second narrowed end. Ideally, in step 940, the first and second end pieces are independently selected to provide a suitable degree of narrowing as appropriate for the respective ends.

It is also contemplated in step 950 that a second filter element could be used in producing the filtration device. For example, a material could be wound about the first and second filter element to form a casing. Again, at least one, and preferably two, end pieces could be used to produce a casing having narrowed ends.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A filter canister, comprising:
a filter element;
a casing formed about the filter element, and having sufficient strength to be used in place of a pressure vessel.

2. The filter canister of claim 1, wherein the filter element comprises a collector tube disposed within a spiral wound filtration material.

3. The filter canister of claim 1, wherein the casing comprises a fiber reinforced plastic.

4. The filter canister of claim 1, wherein the casing comprises fiberglass.

5. The filter canister of claim 1, wherein the casing has a tapered portion.

6. The filter canister of claim 1, further comprising a sensor disposed to sense at least one of flow, temperature, pressure, and conductivity of a fluid within the filter canister.

7. The filter canister of claim 6, further comprising a wireless transmitter coupled to the sensor, and configured to send signals from the sensor.

8. The filter canister of claim 1, further comprising a separation sheet disposed between the filter element and the casing.

9. The filter canister of claim 1, further comprising a second filter element, and wherein the casing is formed about the second filter element.

10. The filter canister of claim 1, further comprising a third filter element, and wherein the casing is formed about the third filter element.

11. The filter element of claim 1, wherein the filter element has a first filter composition that is different from a second filter composition of the second filter element.

12. A filtration system comprising a filter canister of claim 1, further comprising a feed fluid inlet, a permeate outlet, a flow-by outlet, and a distinct injector port.

13. The filtration system of claim 12, further comprising a first tapered end, and wherein the permeate outlet is disposed concentrically within the first tapered end.

14. The filtration system of claim 12, further comprising a first tapered end, and wherein the permeate outlet is disposed eccentrically within the first tapered end.

15. A filtration system comprising:
first and second sets of filter canisters of claim 1, wherein the first and second sets are disposed in series;
a feed fluid inlet coupled to the first set;
a permeate outlet coupled to at least one of the first and second sets; and
a flow-by outlet coupled to at least one of the first and second sets.

16. A method of producing a filtration device from a filter element, comprising:
providing a first end piece; and
spool winding a material about the filter element and the first end piece to form a casing with at least one narrowed end, the casing able to withstand pressures of at least 40 pounds per square inch.

17. The method of claim 16, further comprising providing a second end piece, and winding the material about the second end piece.

18. The method of claim 16, further comprising selecting the first end piece and a second end piece to provide tapers at each of first and second ends of the filtration device.

19. The method of claim 16, further comprising extending the casing to surround a second filter element.
